(19) United States
(12) Patent Application Publication
(10) Pub. No.: US 2004/0111525 A1
(43) Pub. Date: Jun. 10, 2004

(54) Dynamic web service implementation discovery and selection apparatus and method

(75) Inventors: Philip Theodore Berkland, Austin, TX (US); Gregory Alan Flurry, Austin, TX (US); Simon Antony James Holdsworth, Andover (GB); Elizabeth Ann Hutchison, Winchester (GB)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/314,813

(22) Filed: Dec. 9, 2002

(51) Int. Cl. G06F 15/16

(52) U.S. Cl. 709/231; 709/203

(57) ABSTRACT

The present invention provides a mechanism for the dynamic discovery and selection of web service implementations at runtime without explicit client control. With the mechanism of the present invention, service requests are received from clients and a portType or other type identifier of operations that need to be supported by a service implementation is identified. A discovery mechanism is invoked for querying service information sources to identify candidates from these sources that support the portType or operations identified. A list of these candidates is compiled and a selection mechanism is used to select a candidate from the compiled list. The selected candidate is then used to generate a service object used by a client for accessing the actual service implementation.

### BACKGROUND OF THE INVENTION

1. Technical Field

The present invention is directed to a dynamic web service implementation discovery and selection apparatus and method. More specifically, the present invention is directed to support for runtime mechanisms that discover implementations of a desired service type and then select the best implementation for that service type.

2. Description of Related Art

In service-oriented architectures, the fundamental premise is the reuse of web services across one or more enterprise applications. Web services are services that are offered across the Internet that are built using standard technologies that allow interoperability between systems and applications. Web services are typically invoked by enterprise applications to perform some extended functionality not otherwise available in the enterprise application itself. The enterprise applications and their associated enterprise systems are often referred to as “clients” of the web services that they invoke.

Typically, clients of web services must identify a particular implementation of a web service to invoke. Identification of the particular implementation of a web service to invoke is typically performed at design time, i.e. at the time that the enterprise applications/system is being designed. In other words, the bindings with a particular web services are set at design time and new bindings cannot be added at runtime.

International Business Machines, Inc. (IBM) has developed the Web Services Invocation Framework (WSIF) which is a tool that provides a standard application program interface (API) for invoking services described in the Web Services Description Language (WSDL), no matter how or where the services are provided. WSDL is a standard language used to describe a Web service. Co-developed by Microsoft and IBM, WSDL describes the protocols and formats used by the service. WSDL descriptions can be referenced in a Universal Description, Discovery and Integration (UDDI) directory in order to promote the use of Web services worldwide.

The WSIF architecture enables developers to interact with WSDL-based representations of Web services instead of working directly with the Simple Object Access Protocol (SOAP) APIs, which is the usual programming model. With WSIF, developers can work with the same programming model regardless of how the Web service is implemented and accessed.

The WSIF architecture also allows stub-based and stub-less invocation of Web services. A stub is a small software routine placed into a program that provides a common function. Stubs are used for a variety of purposes. For example, a stub may be installed in a client machine, and a counterpart installed in a server, where both are required to resolve some protocol, remote procedure call (RPC) or other interoperability requirement. With the WSIF architecture, no stub is necessary, and the services can be dynamically invoked.

Using WSIF, a client passes a WSDL description of a desired web service to a service factory. The service factory generates a “proxy” for the web service that corresponds to the service element in the WSDL description. The service element defines a number of ports, each of which corresponds to a different format and protocol, that can be used to access the web service described by the WSDL. Typically, all ports map a particular WSDL portType. A “portType” in WSDL is a collection of operations that have been previously defined for a service interface. Known WSIF allows the client to select the port of the service or allows the port to be automatically selected at runtime, but supports only a default selection of the first port encountered. Thus, if more than one port are associated with a particular service, the first port will always be selected.

Once the desired port is identified, it is then used by the client to identify an operation. Eventually, the client calls an “execute” method on the identified operation to actually invoke the service implementation.

Thus, with known service invocation frameworks, the implementation of a web service that is to be invoked is set at design time, or can be explicitly chosen by the client at run time, such as in WSIF. The known systems do not provide an ability to dynamically discover and select a particular implementation of a web service at runtime without explicit action on the part of the client. Furthermore, known systems do not allow for discovery and selection of implementations of services from a group of similar services based on selection preferences without explicit action on the part of the client.

In view of the above, it would be beneficial to have an apparatus and method for dynamic discovery and selection of implementations of web services at runtime as part of the act of invoking the web service, to simplify the client programming model and maximize environmental control of the web services used by a client.

### SUMMARY OF THE INVENTION

The present invention provides a mechanism for the dynamic discovery and selection of web service implementations at runtime. With the mechanism of the present invention, service requests are received from clients and a portType or other type identifier of operations that need to be supported by a service implementation is identified. A discovery mechanism is provided for querying service information sources to identify candidates from these sources that support the portType or operations identified. A list of these candidates is compiled and a selection mechanism is used to select a candidate from the compiled list. The selected candidate is then used to generate a service object for accessing the actual service implementation. These and other features will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in which the present invention may be implemented;

FIG. 2 is an exemplary diagram of a server computing device with which the present invention may operate;

FIG. 3 is an exemplary diagram of a client computing device in which the present invention may be implemented;

FIG. 4 is an exemplary diagram illustrating a web services framework runtime view in accordance with the present invention;

FIG. 5 is an exemplary diagram illustrating a web services framework configuration file;

FIG. 6 is an exemplary diagram illustrating a signature for a discovery mechanism in accordance with the present invention;

FIG. 7 is an exemplary diagram illustrating a signature for a selection mechanism in accordance with the present invention;

FIG. 8 is a flowchart outlining an exemplary operation of the present invention with regard to a web services framework service factory;

FIG. 9 is a flowchart outlining an exemplary operation of the present invention with regard to runtime discovery and selection of a web service implementation; and

FIG. 10 is an exemplary diagram illustration code for using the dynamic runtime discovery and selection of web services implementations in accordance with the present invention.

### DETAILED DESCRIPTION OF THE PREFERRED EMBODIMENT

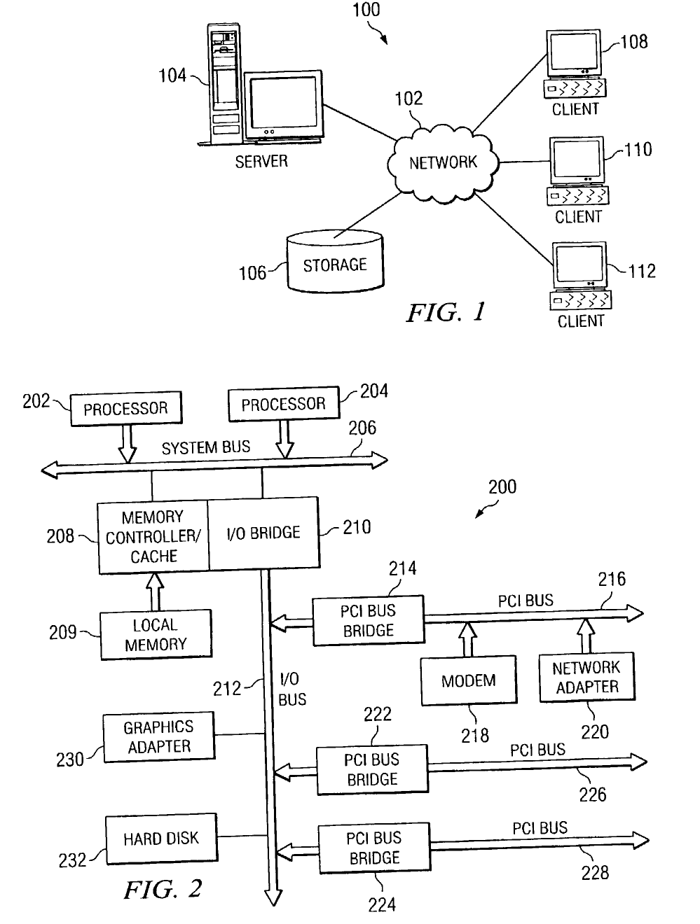

As previously mentioned, the present invention is directed to apparatus and methods for the dynamic runtime discovery and selection of web service implementations. Since the present invention is directed to the discovery and selection of web services, it is prudent to first provide a brief description of the environment in which the present invention may operate. Thus, FIGS. 1-3 provide exemplary diagrams of the computing network and computing devices in which the present invention operates. FIGS. 1-3 are exemplary and are intended to provide a context for the remaining description.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

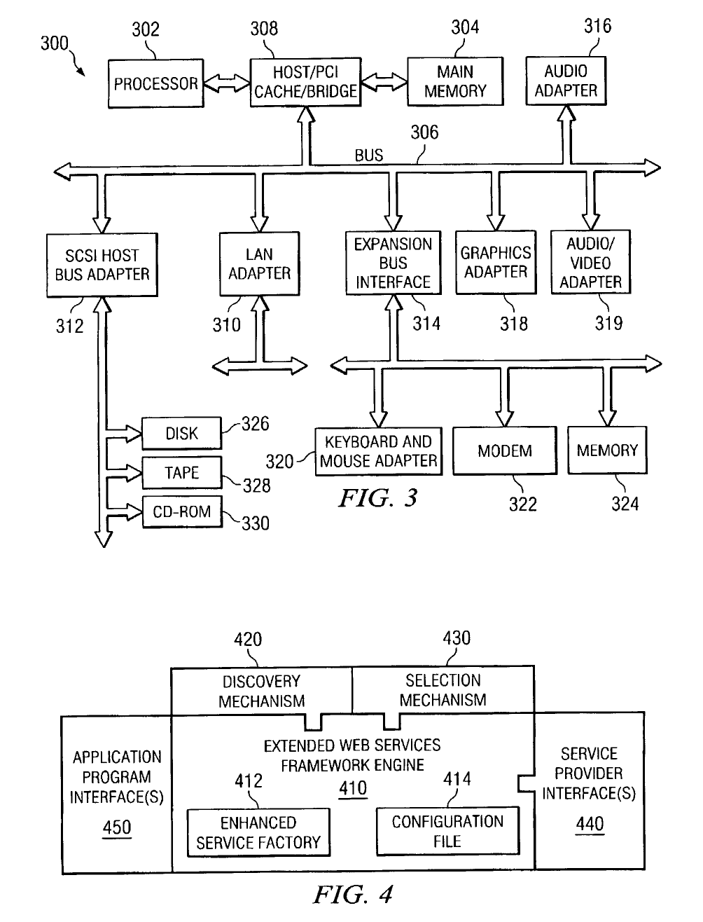

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With continued reference to FIG. 1, the present invention provides a mechanism for dynamic identification of web services at runtime. That is, in the distributed data processing system depicted in FIG. 1, some servers, such as server 104, may provide web services that may be invoked by business applications of web services client devices, such as client devices 108 and 110. With the present invention, the particular implementation of a web service to be invoked by a business application is identified dynamically at runtime based on certain criteria rather than having the implementation fixed at design time.

The present invention will be described in terms of an extension to the Web Services Invocation Framework (WSIF) available from International Business Machines, Inc. (see www.alphaworks.ibm.com/tech/wsif for more information regarding WSIF). However, the present invention is not limited to use with the WSIF architecture. The present invention may be used with other types of web services frameworks, such as Apache Axis or Java JAX-RPC, and the like, without departing from the spirit and scope of the present invention.

With regard to the exemplary embodiments herein which are illustrated as an extended version of the WSIF, the present invention provides an enhanced “service factory” that is used to perform dynamic discovery and selection of web services implementations at runtime. In standard WSIF, a service factory is provided that is used to generate a “proxy” for a service that is used by a client device to access an actual service implementation on a server.

With standard WSIF, a Web Services Description Language (WSDL) document is provided to the service factory. The WSDL document contains a service element, which in turn contains one or more port elements. The port element of a WSDL document describes the binding and an endpoint for that binding. The binding relates a portType to the protocol, e.g., HyperText Transport Protocol (HTTP), to be used to access the web service and the endpoint is the particular source of the web service, e.g., www.alphaworks.ibm.com is an endpoint. The portType is a collection of operations that have been defined for the web service, i.e. the portType is an abstract definition of the interface for the web service.

From a WSDL definition, the service factory in the known WSIF generates a service object that is used to access the web service identified by the binding and the endpoint. Thus, in standard WSIF, the particular implementation of a web service that is to be invoked by a business application is set by the WSDL document passed to the service factory.

With the present invention, an enhanced “service factory” is provided that examines the portType information for a desired service. When a client uses the enhanced service factory of the present invention to generate a service object, the enhanced service factory first invokes a pluggable discovery mechanism, giving it the WSDL description of the service and portType information. From the WSDL description and the portType, the enhanced service factory compiles, via the pluggable discovery mechanism, a list of candidate web services implementations that implement the identified portType. This may be done by querying a UDDI registry, a Web Services Inspection Language (WSIL) registry, and the like, to identify registered web services implementations that implement the identified portType. Alternatively, more complex searches may be performed using the same portType information and/or additional information, e.g. a webcrawler type device may be used to identify services that implement the identified portType.

Once the candidate list is compiled by the enhanced service factory, the list is provided to a pluggable selection mechanism that selects an implementation from the candidate list to be used to generate the service object for the business application. The selection mechanism selects a candidate from the candidate list based on criteria established by the pluggable selection mechanism. This criteria may be, for example, service level agreements, cost, availability, enterprise preferences, or basically any criteria the selection mechanism chooses to use.

Once a candidate is selected, a service object is created in the manner known in the art. Thus, the present invention provides a mechanism for dynamically selecting a web service implementation at runtime based on established criteria. This criteria may, in itself, be dynamically changeable by modifying the rules and/or parameters used by the selection mechanism for selecting a candidate from the candidate list. Similarly, the discovery mechanism may be dynamically changeable by changing the particular registries and/or operations performed to identify candidate service implementations.

Now a more detailed description of an exemplary embodiment of the present invention will be provided with reference to FIGS. 4-10. It should be appreciated that these figures are only exemplary and are not intended to imply any limitation to the present invention. Other implementations of the present invention may be used without departing from the spirit and scope of the present invention.

FIG. 4 is an exemplary diagram illustrating an web services framework runtime view in accordance with the present invention. The particular embodiment shown in FIG. 4 is an enhanced version of WSIF in which pluggable discovery and selection mechanisms are provided and in which the application program interfaces are adapted to make use of the discovery and selection mechanisms. However, the present invention, as previously discussed, is not limited to WSIF. Rather, any web services framework in which dynamic discovery and selection mechanisms according to the present invention may be used, is intended to be within the spirit and scope of the present invention.

As shown in FIG. 4, an extended web services invocation framework (WSIF) engine 410 is provided with a pluggable discovery mechanism 420, a pluggable selection mechanism 430, pluggable web services provider interfaces 440, and application program interfaces 450 which are adapted to implement the discovery and selection mechanisms in the manner described hereafter. The extended WSIF engine 410 includes an enhanced service factory 412 and a configuration file 414, among other elements not explicitly shown. The elements 410, 412 and 420-450 may be implemented in software, hardware, or any combination of software and hardware. In a preferred embodiment, the elements 410, 412 and 420-450 are implemented as software instructions executed by one or more computing devices.

The extended WSIF engine 410 provides a framework for the invocation of web services by business applications. The extended WSIF engine 410 according to the present invention is enhanced over known WSIF engines in that the extended WSIF engine 410 is enhanced to make use of the pluggable discovery mechanism 420 and selection mechanism 430. With the extended WSIF engine 410, a configuration file 414 is provided that identifies the service portTypes that are known by the extended WSIF engine 410 as well as default discovery and selection mechanisms that are used in the case that a requested service portType is not known by the extended WSIF engine 410.

The enhanced service factory 412 is invoked by service requests from business applications received via the application program interfaces 450. The enhanced service factory 412, in response to receiving a WSDL description of a desired service from a client via the application program interfaces 450, identifies a portType of the desired service and invokes the discovery mechanism 420 to identify candidate service implementations. Specifically, the enhanced service factory 412 compares the requested portType against the configuration file 414. If the portType is present in the configuration file, the associated discovery and selection attributes are used to govern the discovery and selection of candidate service implementations. If the portType is not present in the configuration file, then default discovery and selection attributes are used.

The discovery mechanism 420 invoked, in a preferred embodiment, is identified by the discovery parameter identified in the configuration file 414. When the discovery mechanism 420 receives the portType from the enhanced service factory 412, the discovery mechanism 420 performs a search of sources for services that implement the portType. Alternatively, a more complex search may be performed based on a rules set associated with the identified discovery mechanism 420. In a preferred embodiment, a discovery mechanism 420 sends queries to registries, such as a UDDI and/or WSIL registry, requesting that information associated with services implementing the identified portType be returned to the discovery mechanism 420. This information may include, for example, the WSDL document, binding and/or endpoint for the registered web service implementation. The discovery mechanism 420 compiles a candidate list based on the responses received and provides this candidate list to the enhanced service factory 412.

The enhanced service factory 412 then provides the candidate list to the selection mechanism 430 identified from the configuration file 414. The selection mechanism 430 uses a rule set and parameters for identifying which of the candidates from the candidate list should be selected for use in creating the service object that will be used by the business application for invoking a service implementation. The particular rules and parameters utilized are dependent on the particular selection mechanism. Examples of such rules include, but are not limited to, requirements based on a service level agreement, cost, availability, geographic proximity, and the like.

The selection mechanism 430 selects a candidate from the candidate list and provides the selected candidate to the enhanced service factory 412. The enhanced service factory 412 then operates in a known manner to generate a service object for invoking the selected implementation of the requested service. The selected implementation of the requested service may then be accessed using the service object via the provider interfaces 440.

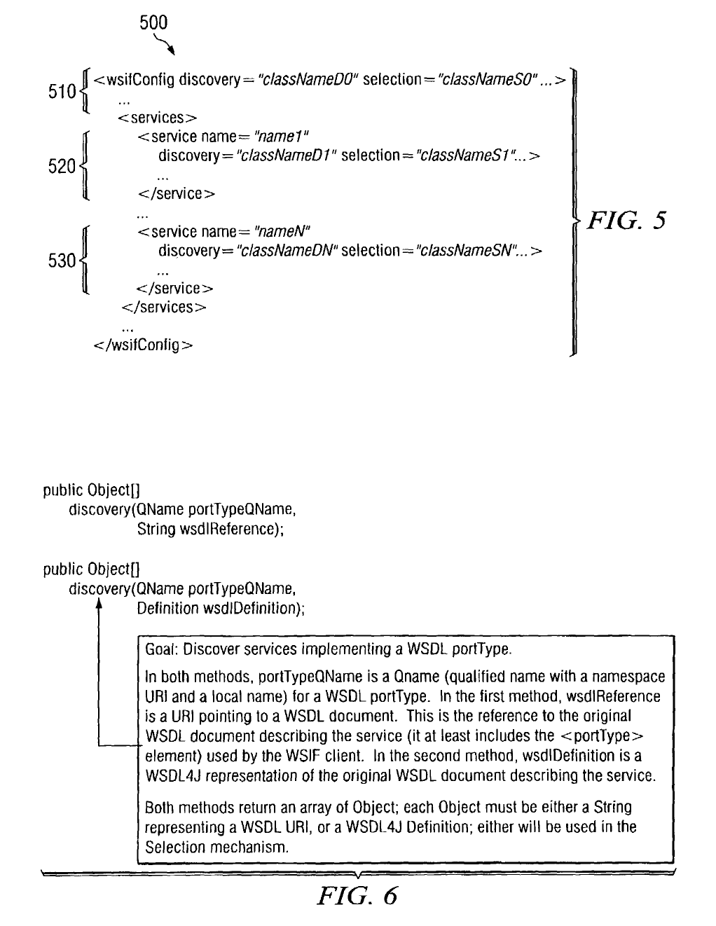

FIG. 5 is an exemplary diagram illustrating a web services framework configuration file according to one embodiment of the present invention. As shown in FIG. 5, the configuration file 500 according to a preferred embodiment is an XML file in which service portTypes are listed with associated parameters including a discovery parameter and selection parameter.

In the “<wsifConfig>” element 510, discovery and selection attributes allow identification of global discovery and selection modules of the discovery and selection mechanisms 420 and 430. In other words, the <wsifConfig> element 510 identifies a default discovery and selection mechanism used when the other portTypes listed in the configuration file 500 do not match a requested portType.

A service element 520-530 contains similar parameters of discovery mechanism identifier parameter and selection mechanism identifier parameter in addition to other possible parameters. The “service name” attribute of the services identifies a portType qualified name, or QName, which is a namespace and local name.

When a request for a service implementation is received from a client, the request identifies the requested portType. The enhanced service factory then searches the configuration file 500 to determine if the requested portType is listed in the configuration file 500. If so, the associated discovery and selection parameters identify the mechanisms used for the discovery and selection of a candidate service implementation.

It should be noted that the configuration file may be updated dynamically and thus, the discovery and selection mechanisms used for a particular portType may be changed or added dynamically.

FIG. 6 is an exemplary diagram illustrating a signature for a discovery mechanism in accordance with the present invention. As shown in FIG. 6, the signature contains a parameter “wsdlReference” or “wsdlDefinition” that allows the WSIF engine to determine the WSDL offered by the client as the service it wants to use. The “wsdlDefinition” may contain only portType information, portType and binding information, or portType, binding, and service (which includes port) information.

The other parameter of the exemplary signature is the qualified name (QName) of the portType requested. The portTypeQName provides the QName of the requested portType to the enhanced service factory for use in identifying candidate services that implement the requested portType. Based on this QName of the portType, the discovery mechanism searches registries or the like to identify candidate service implementations. The discovery mechanism then returns an array, or list, of candidate service implementations. This array, or list, may contain Universal Resource Locators (URLs) pointing to WSDL documents for a service implementation, the WSDL document for the service implementation, a WSDL4J Definition derived from the WSDL document for the service implementation, or the like. This array or list is then provided to the selection mechanism for selection of a particular candidate from the array or list.

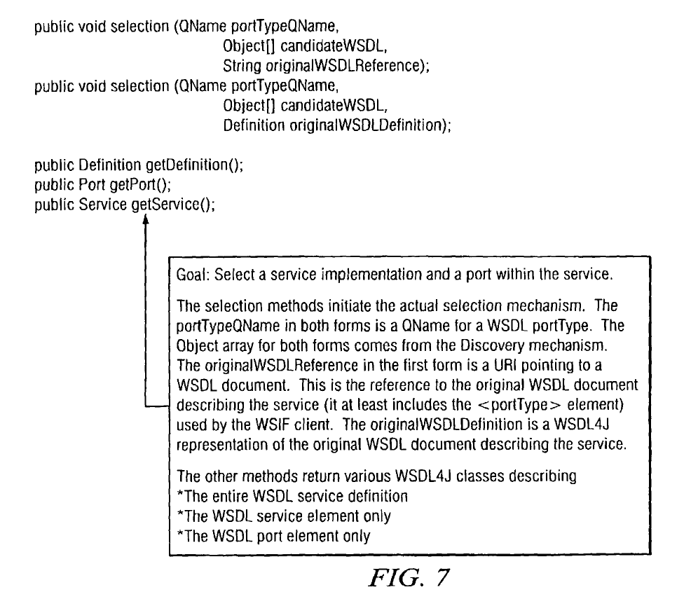

FIG. 7 is an exemplary diagram illustrating a signature for a selection mechanism in accordance with the present invention. As shown in FIG. 7, the signature includes two selection methods that correspond to two different output types of the discovery mechanism. The input parameters for the selection methods include the input parameters given to the discovery mechanism and the output array or list produced by the discovery mechanism. The selection methods choose one of the candidate service implementations offered by the discovery mechanism. In addition, the selection mechanism chooses the desired port of the service implementation. The other methods return particular elements also governed by the selection process, e.g., the service or port within the service.

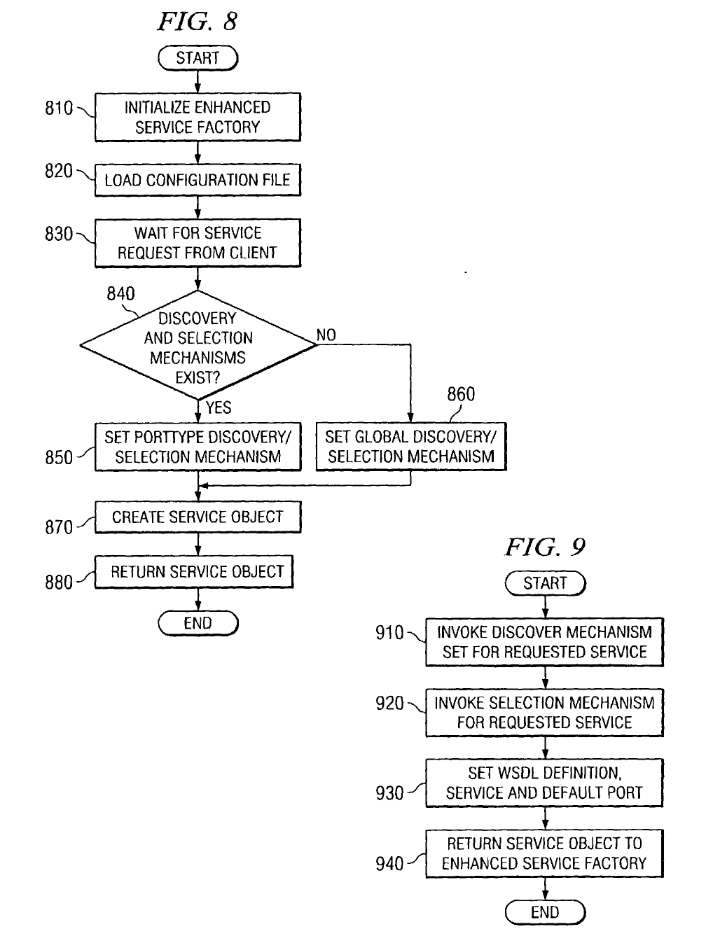

FIG. 8 is a flowchart outlining an exemplary operation of the present invention with regard to a web services framework enhanced service factory. As shown in FIG. 8, the enhanced service factory is initialized (step 810) and loads the configuration file (step 820). The enhanced service factory then waits for a request from a client device requesting a service implementation (step 830). The enhanced service factory then determines if discovery and selection mechanisms exist for the requested portType by searching the configuration file (step 840). If so, the discovery and selection mechanisms are set based on the parameters retrieved from the configuration file (step 850). If not, then global, or default, discovery and selection mechanisms are set (step 860). The operation then creates the service object using the discovery and selection mechanisms set for the service (step 870), and returns the service object to the client (step 880).

FIG. 9 is a flowchart outlining an exemplary operation of the present invention with regard to runtime discovery and selection of a web service implementation. The operation shown in FIG. 9 corresponds to step 870 in FIG. 8. As shown in FIG. 9, the operation starts by invoking the discovery mechanism set for the service requested (step 910). The result of the discovery mechanism operation is an array or list of candidate service implementations. The selection mechanism set for the service requested is then invoked (step 920) to select a particular candidate from the array or list. The WSDL definition, service, and default port are then set based on the selection (step 930) and the operation returns the service object to the enhanced service factory (step 940).

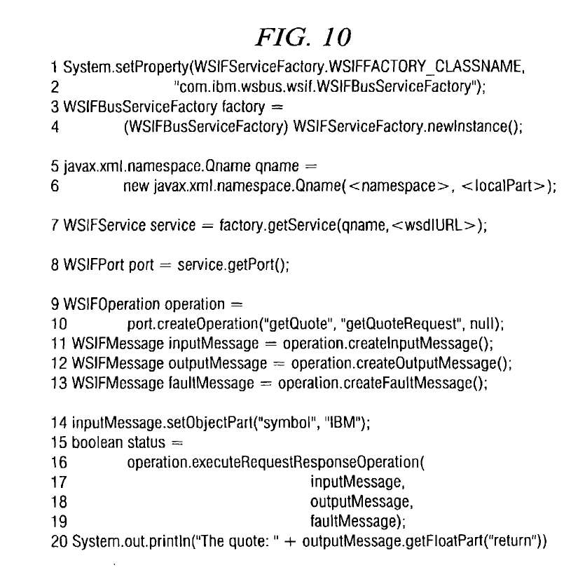

FIG. 10 is an exemplary diagram illustration code for using the dynamic runtime discovery and selection of web services implementations in accordance with the present invention. The code shown in FIG. 10 is code that may be incorporated into business applications or an application program interface that is used to communicate with the extended WSIF engine. The particular example shown is in the Java programming language, however the present invention may be implemented in any programming language desirable. In addition, the particular example shown is for a stock quote service, but any service may be the basis of the discovery and selection mechanisms of the present invention.

The majority of the example shown in FIG. 10 is similar to standard WSIF and thus, a detailed description of these sections will not be provided. Only those sections of the depicted example that are different from standard WSIF will be described.

As shown in FIG. 10, lines 1-2 are used to set up the class name of the enhanced service factory in the extended WSIF engine. The name “com.ibm.wsbus.wsif.WSIFBusServiceFactory” is used to identify the enhanced service factory in the depicted example, however the name can clearly be different depending on the particular implementation of the present invention. Lines 3 and 4 are used to obtain an instance of the enhanced service factory. It should be noted that lines 1-4 would only be executed once for any client device in order to set up the web services invocation framework environment.

Lines 5 and 6 are used to set the qualified name for the portType for a particular desired service. This would be done for every service used by the client device.

Line 7 is the signature for the enhanced service factory. A standard service factory signature would not include the “qname” parameter. The discovery and selection mechanisms of the present invention, in the depicted example, are actually invoked during the execution of a “getService” method in the enhanced service factory.

Thus, the present invention provides a mechanism by which web service implementations are selected dynamically at runtime without explicit client action. The present invention provides mechanisms for discovering candidate service implementations that implement a desired portType and for selecting one service implementation from the discovered candidates. In this way, the particular service implementation of a web service used by a business application need not be fixed prior to runtime. Moreover, the particular candidate selected may change based on circumstances and/or parameters associated with the discovery and selection of candidates.

It should be appreciated that, while the exemplary embodiments discussed above are described in terms of portType, the present invention is not limited to such. Rather, any identifier of a set of operations to be supported by the service implementation may be used without departing from the spirit and scope of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for selecting a web service for use by a client device, comprising:
receiving a request for a web service, the request including an identifier associated with a portType that must be supported by the web service;
compiling a list of candidate web service implementations based on the identifier;
selecting a candidate from the list of candidate web service implementations based on selection criteria;
generating a service object based on the selected candidate; and
providing the service object to the client device for use in accessing the web service.

2. The method of claim 1, wherein compiling the list of candidate web service implementations includes:
sending a request to a registry of web services, the request including the identifier; and
receiving results from the registry having a list of one or more registered web service implementations that implement the portType associated with the identifier.

3. The method of claim 1, wherein the identifier is a portType of a web services description language (WSDL) document provided in the request.

4. The method of claim 1, wherein compiling a list of candidate web service implementations includes:
providing a web service discovery language (WSDL) definition of the requested web service to a pluggable discovery mechanism; and
identifying candidate web service implementations that implement a portType identified in the WSDL definition based on registries and operations associated with the discovery mechanism.

5. The method of claim 1, wherein the selection criteria include at least one of service level agreements, cost, availability, and enterprise preferences.

6. The method of claim 1, wherein selecting a candidate from the list of candidate web service implementations based on selection criteria includes:
providing the list of candidate web service implementations to a pluggable selection mechanism; and
selecting the candidate from the list based on selection rules and parameters associated with the selection mechanism.

7. The method of claim 4, wherein the registries and operations associated with the discovery mechanism are dynamically changeable.

8. The method of claim 6, wherein the selection rules and parameters associated with the selection mechanism are dynamically changeable.

9. The method of claim 1, further comprising:
selecting a discovery mechanism based on a configuration file, wherein the discovery mechanism is used to compile the list of candidate web service implementations based on the identifier.

10. The method of claim 9, wherein the discovery mechanism is selected based on a portType of the requested web service.

11. The method of claim 6, further comprising:
selecting a selection mechanism based on a configuration file, wherein the selection mechanism is used to select a candidate from the list of candidate web service implementations based on selection criteria.

12. The method of claim 11, wherein the selection mechanism is selected based on a portType of the requested web service.

13. The method of claim 12, wherein the selection mechanism is a default selection mechanism if a specific selection mechanism is not provided for the portType of the requested web service in the configuration file.

14. The method of claim 10, wherein the discovery mechanism is a default discovery mechanism if a specific discovery mechanism is not provided for the portType of the requested web service in the configuration file.

15. A computer program product in a computer readable medium for selecting a web service for use by a client device, comprising:
first instructions for receiving a request for a web service, the request including an identifier associated with a portType that must be supported by the web service;
second instructions for compiling a list of candidate web service implementations based on the identifier;
third instructions for selecting a candidate from the list of candidate web service implementations based on selection criteria;
fourth instructions for generating a service object based on the selected candidate; and
fifth instructions for providing the service object to the client device for use in accessing the web service.

16. The computer program product of claim 15, wherein the second instructions for compiling the list of candidate web service implementations include:
instructions for sending a request to a registry of web services, the request including the identifier; and
instructions for receiving results from the registry having a list of one or more registered web service implementations that implement the portType associated with the identifier.

17. The computer program product of claim 15, wherein the identifier is a portType of a web services description language (WSDL) document provided in the request.

18. The computer program product of claim 15, wherein the second instructions for compiling a list of candidate web service implementations include:
instructions for providing a web service discovery language (WSDL) definition of the requested web service to a pluggable discovery mechanism; and
instructions for identifying candidate web service implementations that implement a portType identified in the WSDL definition based on registries and operations associated with the discovery mechanism.

19. The computer program product of claim 15, wherein the selection criteria include at least one of service level agreements, cost, availability, and enterprise preferences.

20. The computer program product of claim 15, wherein the third instructions for selecting a candidate from the list of candidate web service implementations based on selection criteria include:
instructions for providing the list of candidate web service implementations to a pluggable selection mechanism; and
instructions for selecting the candidate from the list based on selection rules and parameters associated with the selection mechanism.

21. The computer program product of claim 18, wherein the registries and operations associated with the discovery mechanism are dynamically changeable.

22. The computer program product of claim 20, wherein the selection rules and parameters associated with the selection mechanism are dynamically changeable.

23. The computer program product of claim 15, further comprising:
sixth instructions for selecting a discovery mechanism based on a configuration file, wherein the discovery mechanism is used to compile the list of candidate web service implementations based on the identifier.

24. The computer program product of claim 23, wherein the discovery mechanism is selected based on a portType of the requested web service.

25. The computer program product of claim 15, further comprising:
sixth instructions for selecting a selection mechanism based on a configuration file, wherein the selection mechanism is used to select a candidate from the list of candidate web service implementations based on selection criteria.

26. The computer program product of claim 25, wherein the selection mechanism is selected based on a portType of the requested web service.

27. The computer program product of claim 26, wherein the selection mechanism is a default selection mechanism if a specific selection mechanism is not provided for the portType of the requested web service in the configuration file.

28. The computer program product of claim 23, wherein the discovery mechanism is a default discovery mechanism if a specific discovery mechanism is not provided for the portType of the requested web service in the configuration file.

29. An apparatus for selecting a web service for use by a client device, comprising:
means for receiving a request for a web service, the request including an identifier associated with a portType that must be supported by the web service;
means for compiling a list of candidate web service implementations based on the identifier;
means for selecting a candidate from the list of candidate web service implementations based on selection criteria;
means for generating a service object based on the selected candidate; and
means for providing the service object to the client device for use in accessing the web service.
